(19) United States
(12) Patent Application Publication
(10) Pub. No.: US 2010/0139703 A1
(43) Pub. Date: Jun. 10, 2010

(54) LIQUID PROCESSING METHOD, LIQUID PROCESSING APPARATUS, AND STORAGE MEDIUM

(75) Inventor: Hiromitsu NAMBA, Koshi City (JP)

Correspondence Address: CANTOR COLBURN, LLP, 20 Church Street, 22nd Floor, Hartford, CT, 06103, US

(73) Assignee: TOKYO ELECTRON LIMITED, Tokyo (JP)

(21) Appl. No.: 12/632,496

(22) Filed: Dec. 7, 2009

(30) Foreign Application Priority Data
Dec. 8, 2008 (JP) 2008-312241

(51) Int. Cl. B08B 3/00

(52) U.S. Cl. 134/26; 134/95.2

(57) ABSTRACT

Disclosed is a liquid processing method. The liquid processing method can completely clean an inside of a multi-valve for a short time and process a wafer with high throughput. The liquid processing method supply a chemical liquid and a rinsing liquid to the substrate so as to process the substrate through a multi-valve and a cleaning-liquid supply pipe connected to the multi-valve. The multi-valve includes a chemical-liquid supply valve, a rinsing-liquid supply valve, and a discharge valve. The cleaning-liquid supply pipe guides the chemical liquid and rinsing liquid from the multi-valve toward the substrate. The liquid processing method includes supplying the chemical liquid to the substrate by opening the chemical-liquid supply valve, and supplying a portion of the rinsing liquid supplied from a rinsing-liquid supply part to the substrate and flowing the residue of the rinsing liquid toward the discharge path within the multi-valve by opening both the rinsing-liquid supply valve and the discharge valve after supplying the chemical liquid.

This application is based on and claims priority from Japanese Patent Application No. 2008-312241, filed on Dec. 8, 2008, with the Japanese Patent Office, the disclosure of which is incorporated herein in its entirety by reference.

### TECHNICAL FIELD

The present disclosure relates to a liquid processing method to supply a cleaning liquid to a substrate and process the substrate with the cleaning liquid, a liquid processing apparatus to perform the liquid processing method, and a storage medium to allow the liquid processing apparatus to perform the liquid processing method.

### BACKGROUND

Conventionally, a substrate processing unit (a liquid processing apparatus) includes a chamber to process a substrate, which is a to-be-processed object, in an inside of the chamber, a processing-liquid supply pipe (a cleaning-liquid supply pipe) connected to an upstream side of the chamber, a chemical-liquid supply pipe connected to the processing-liquid supply pipe to supply a chemical liquid to the processing-liquid supply pipe, a rinsing-liquid supply pipe connected to the processing-liquid supply pipe to supply a rinsing liquid to the processing-liquid supply pipe, a multi-valve to connect the upstream end of the processing-liquid supply pipe with the chemical-liquid supply pipe and the rinsing-liquid supply pipe (for example, see Japanese Laid-Open Patent No. 2007-317927).

A substrate processing method using the substrate processing unit includes supplying the chemical liquid from the chemical-liquid supply pipe to the processing-liquid supply pipe to process the substrate, and then supplying the rinsing liquid from the rinsing-liquid supply pipe to the processing-liquid supply pipe to process the substrate.

However, in the conventional substrate processing unit, when the chemical liquid is supplied from the chemical-liquid supply pipe to the processing-liquid supply pipe, the chemical liquid is attached to an inside of the multi-valve. When a high-concentration chemical liquid or a chemical liquid having a stronger affinity for the multi-valve than for the rinsing liquid is used, such an attachment becomes notable. Therefore, when the rinsing liquid is supplied to the substrate, the chemical liquid within the multi-valve is mixed with the rinsing liquid and supplied to the substrate. As a result, the substrate may be over-etched by the chemical liquid. Further, since it needs the time for supplying the rinsing liquid to increase for discharging the chemical liquid within the processing-liquid supply pipe and the multi-valve, the throughput of processing the substrate may deteriorate.

### SUMMARY

According to one embodiment, there is provided a liquid processing method to process a substrate with a chemical liquid and a rinsing liquid supplied through a multi-valve and a cleaning-liquid supply pipe connected to the multi-valve. The multi-valve includes a chemical-liquid supply valve installed at a chemical-liquid supply pipe, a rinsing-liquid supply valve installed at a rinsing-liquid supply pipe, and a discharge valve installed at a discharge path. The cleaning-liquid supply pipe guides the chemical liquid and the rinsing liquid from the multi-valve toward the substrate. The method includes supplying the chemical liquid supplied from a chemical-liquid supply part to the substrate through the cleaning-liquid supply pipe by opening the chemical-liquid supply valve, and supplying a portion of the rinsing liquid supplied from a rinsing-liquid supply part to the substrate through the cleaning-liquid supply pipe and flowing the residue of the rinsing liquid toward the discharge path within the multi-valve by opening both the rinsing-liquid supply valve and the discharge valve after supplying the chemical liquid.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view schematically illustrating the configuration of a liquid processing apparatus according to a first embodiment.

FIGS. 2(a) to 2(h) are the views schematically illustrating a liquid processing method according to a first embodiment.

FIGS. 3(a) to 3(b) are the views schematically illustrating a liquid processing method according to a modification of the first embodiment.

FIG. 4 is a view schematically illustrating the configuration of a liquid processing apparatus according to another modification of the first embodiment.

FIG. 5 is a view schematically illustrating the configuration of a liquid processing apparatus according to a second embodiment.

FIGS. 6(a) to 6(f) are the views schematically illustrating a liquid processing method according to a second embodiment.

### DETAILED DESCRIPTION

In the following detailed description, reference is made to the accompanying drawing, which form a part hereof The illustrative embodiments described in the detailed description, drawing, and claims are not meant to be limiting. Other embodiments may be utilized, and other changes may be made, without departing from the spirit or scope of the subject matter presented here.

The present disclosure provides a liquid processing method, a liquid processing apparatus, and a storage medium. The liquid processing method can completely clean an inside of a multi-valve with a rinsing liquid within a short time and process a substrate with the high throughput without over-etching. The liquid processing apparatus performs the liquid processing method, and a storage medium allows the liquid processing apparatus to perform the liquid processing method

According to one embodiment, there is provided a liquid processing method to process a substrate with a chemical liquid and a rinsing liquid supplied through a multi-valve and a cleaning-liquid supply pipe connected to the multi-valve. The multi-valve includes a chemical-liquid supply valve installed at a chemical-liquid supply pipe, a rinsing-liquid supply valve installed at a rinsing-liquid supply pipe, and a discharge valve installed at a discharge path. The cleaning-liquid supply pipe guides the chemical liquid and the rinsing liquid from the multi-valve toward the substrate. The method includes supplying the chemical liquid supplied from a chemical-liquid supply part to the substrate through the cleaning-liquid supply pipe by opening the chemical-liquid supply valve, and supplying a portion of the rinsing liquid supplied from a rinsing-liquid supply part to the substrate through the cleaning-liquid supply pipe and flowing the residue of the rinsing liquid toward the discharge path within the multi-valve by opening both the rinsing-liquid supply valve and the discharge valve after supplying the chemical liquid.

According to another embodiment, a liquid processing apparatus is provided. The liquid processing apparatus includes a multi-valve. The multi-valve includes a chemical-liquid supply valve installed at a chemical-liquid supply pipe, a rinsing-liquid supply valve installed at a rinsing-liquid supply pipe, and a discharge valve installed at a discharge path. The liquid processing apparatus also includes a chemical-liquid supply part to supply a chemical liquid for processing a substrate, a rinsing-liquid supply part to supply a rinsing liquid for processing the substrate, a cleaning-liquid supply pipe connected to the multi-valve so as to guide the chemical liquid and the rinsing liquid from the multi-valve toward the substrate, and a control device to control the multi-valve. The control device allows the chemical liquid to be supplied from the chemical-liquid supply part to the substrate by opening the chemical-liquid supply valve, and then the control device allows the rinsing liquid to be supplied from the rinsing-liquid supply part to the substrate and flow toward the discharge path within the multi-valve by opening both the rinsing-liquid supply valve and the discharge valve.

According to further another embodiment, there is provided a storage medium storing a computer program to execute a liquid processing method in a liquid processing apparatus. The liquid processing apparatus includes a multi-valve and a cleaning-liquid supply pipe connected to the multi-valve. The multi-valve includes a chemical-liquid supply valve installed at a chemical-liquid supply pipe, a rinsing-liquid supply valve installed at a rinsing-liquid supply pipe, and a discharge valve installed at a discharge path. The cleaning-liquid supply pipe guides the chemical liquid and the rinsing liquid from the multi-valve toward a substrate. The liquid processing method includes supplying the chemical liquid supplied from a chemical-liquid supply part to the substrate through the cleaning-liquid supply pipe by opening the chemical-liquid supply valve, and supplying a portion of the rinsing liquid supplied from a rinsing-liquid supply part to the substrate through the cleaning-liquid supply pipe and flowing the residue of the rinsing liquid toward the discharge path within the multi-valve by opening both the rinsing-liquid supply valve and the discharge valve after supplying the chemical liquid.

According to one embodiment, a portion of the rinsing liquid is supplied from a rinsing-liquid supply part to the substrate by opening both the rinsing-liquid supply valve and the discharge valve and the residue of the rinsing liquid flows toward the discharge path within the multi-valve. Therefore, the inside of the multi-valve can be completely cleaned with the rinsing liquid for a short time and the substrate can be processed with the high throughput without over-etching.

### First Embodiment

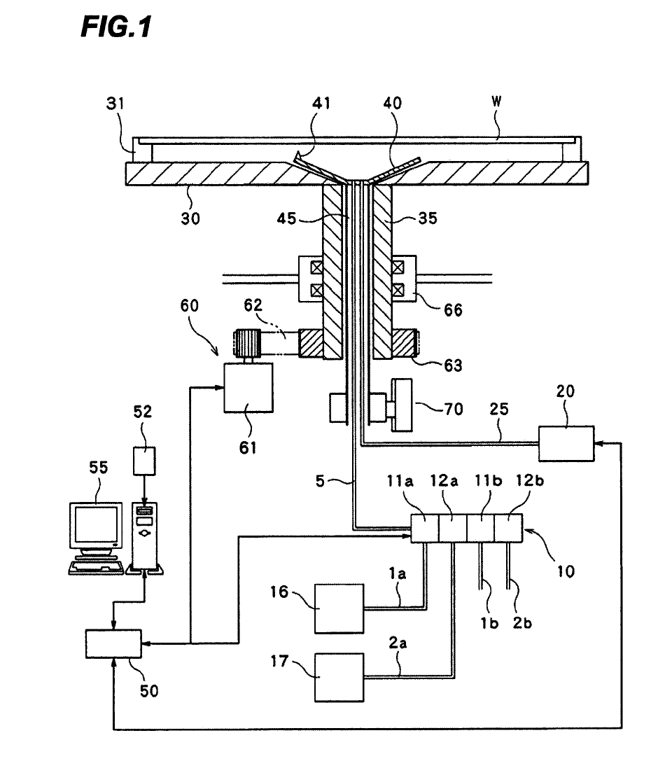

Hereinafter, a liquid processing method, a liquid processing apparatus, and a storage medium according to the first embodiment will be described with reference to the accompanying drawings. Here, FIGS. 1 to 4 are the views illustrating the first embodiment.

As shown in FIG. 1, the liquid processing apparatus includes a hollow-shaped holding plate 30 to hold a semiconductor wafer W that is the substrate (hereinafter, referred to as wafer W) by a holding part 31, a hollow-shaped rotating shaft 35 fixedly connected to holding plate 30, and a rotation driving part 60 to rotate rotating shaft 35 in a rotation direction.

As shown in FIG. 1, rotation driving part 60 includes a pulley 63 disposed outside of a circumferential periphery of rotating shaft 35 and a motor 61 to provide pulley 63 with the driving force through a driving belt 62. Further, a bearing 66 is disposed outside of the circumferential periphery of rotating shaft 35.

Further, as shown in FIG. 1, a lift pin plate 40 having a lift pin 41 to move wafer W up and down in loading and unloading wafer W is disposed within the hollow of holding plate 30. A lift shaft 45 fixedly connected to lift pin plate 40 extends in an up and down direction within the hollow of rotating shaft 35. In FIG. 1, only one lift pin 41 is illustrated, but a plurality of lift pins 41 (for example, three (3) pins) may be disposed in a circumferential direction at a uniform distance from one another.

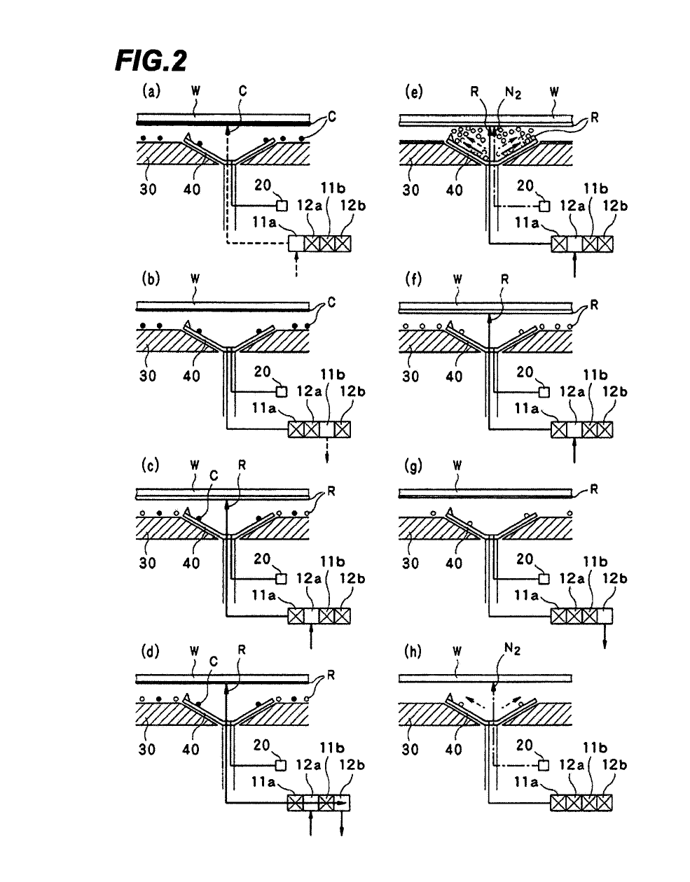

As shown in FIG. 1, a cleaning-liquid supply pipe 5, which configures a chemical-liquid supply pipe when supplying chemical liquid C, extends in an up and down direction within lift shaft 45 and lift pin plate 40. Cleaning-liquid supply pipe 5 supplies cleaning liquids C and R (see FIG. 2) to a lower surface of wafer W (the surface of holding part 31 side) held by holding plate 30. Further, as shown in FIG. 1, a gas supply pipe 25 extends in an up and down direction within lift shaft 45 and lift pin plate 40. Gas supply pipe 25 supplies inert gas or air including N₂ or Ar to a surface (lower surface) of wafer W held by holding plate 30. The inert gas is represented by N₂ in FIGS. 2(e) and 2(h). Further, gas supply pipe 25 is connected with a gas supply part 20 to supply gas to gas supply pipe 25. Here, it is preferred that the gas supplied to wafer W includes the inert gas.

Cleaning liquids C and R in the present disclosure refer to chemical liquid C or rinsing liquid R. For example, concentrated hydrofluoric acid, diluted hydrofluoric acid, ammonia-hydrogen peroxide solution (SC1), hydrochloric acid-hydrogen peroxide solution (SC2), and organic solvent can be used as chemical liquid C. Also, for example, deionized water (DIW) can be used as rinsing liquid R.

As shown in FIG. 1, cleaning-liquid supply pipe 5 is provided with a chemical-liquid supply part 16 to supply chemical liquid C through a multi-valve 10 and a rinsing-liquid supply part 17 to supply rinsing liquid R through multi-valve 10. More particularly, a chemical-liquid supply pipe 1a is connected to chemical-liquid supply part 16 and cleaning-liquid supply pipe 5 is connected to chemical-liquid supply pipe 1a through multi-valve 10. Further, a rinsing-liquid supply pipe 2a is connected to rinsing-liquid supply part 17 and cleaning-liquid supply pipe 5 is connected to rinsing-liquid supply pipe 2a through multi-valve 10. In the present embodiment, a chemical-liquid supply mechanism includes chemical-liquid supply part 16, chemical-liquid supply pipe 1a, a chemical-liquid supply valve 11a (described later), and cleaning-liquid supply pipe 5. A rinsing-liquid supply mechanism includes rinsing-liquid supply part 17, rinsing-liquid supply pipe 2a, a rinsing-liquid supply valve 12a (described later), and cleaning-liquid supply pipe 5.

As shown in FIG. 1, multi-valve 10 is connected with a chemical-liquid discharge pipe 1b to discharge chemical liquid C within cleaning-liquid supply pipe 5 and multi-valve 10. Also, multi-valve 10 is connected with a rinsing-liquid discharge pipe 2b to discharge rinsing liquid R within cleaning-liquid supply pipe 5 and multi-valve 10. Such a discharged chemical liquid C or rinsing liquid R may be processed as the draining liquid or return to chemical-liquid supply pipe 16 or rinsing-liquid supply pipe 17 to be re-used. The present embodiment will describe an aspect of the present disclosure in which discharged chemical liquid C returns to chemical-liquid supply pipe 16 to be re-used and discharged rinsing liquid R is processed as the draining liquid.

Further, multi-valve 10 of the present disclosure includes a plurality of valves and each valve thereof can independently open and close. In the present embodiment, multi-valve 10 includes chemical-liquid supply valve 11a installed between chemical-liquid supply pipe 1a and cleaning-liquid supply pipe 5 to be opened and closed, rinsing-liquid supply valve 12a installed between rinsing-liquid supply pipe 2a and cleaning-liquid supply pipe 5 to be opened and closed, a chemical-liquid discharge valve 11b installed between cleaning-liquid supply pipe 5 and chemical-liquid discharge pipe 1b to be opened and closed, and a rinsing-liquid discharge valve 12b installed between cleaning-liquid supply pipe 5 and rinsing-liquid discharge pipe 2b to be opened and closed. Here, a discharge valve is configured with chemical-liquid discharge valve 11b and rinsing-liquid discharge valve 12b.

Further, as shown in FIG. 1, lift shaft 45 is provided with an elevating member 70 to move lift pin plate 40 and lift shaft 45 up and down and dispose them at an upper position and a lower position.

In the present embodiment, a chemical-liquid supply path is configured with chemical-liquid supply pipe 1a and cleaning-liquid supply pipe 5. A rinsing-liquid supply path is configured with rinsing-liquid supply pipe 2a and cleaning-liquid supply pipe 5. A chemical-liquid discharge path is configured with chemical-liquid discharge pipe 1b. A rinsing-liquid discharge path is configured with rinsing-liquid discharge pipe 2b. Further, a discharge path is configured with the chemical-liquid discharge path (chemical-liquid discharge pipe 1b) and the rinsing-liquid discharge path (rinsing-liquid discharge pipe 2b).

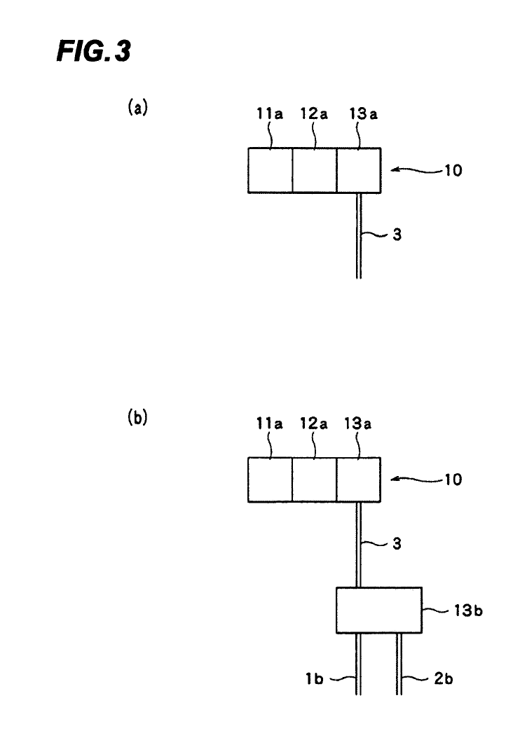

However, the configuration of the discharge path is not limited to the aforementioned aspect. For example, as shown in FIG. 3(a), the discharging path may be configured with a discharge pipe 3 to discharge both chemical liquid C and rinsing liquid R. Further, as shown in FIG. 3(b), the discharge path may be configured with discharge pipe 3 to discharge both chemical liquid C and rinsing liquid R, chemical-liquid discharge pipe 1b connected to discharge pipe 3 through a branch valve 13b to discharge chemical liquid C, and rinsing-liquid discharge pipe 2b connected to discharge pipe 3 through branch valve 13b to discharge rinsing liquid R. In the aspects shown in FIGS. 3(a) and 3(b), a discharge valve 13a is installed instead of chemical-liquid discharge valve 11b and rinsing-liquid discharge valve 12b.

Next, the operation and effect of the present embodiment as described above will be described.

First, lift pin plate 40 is placed at the upper position, at which a wafer carrying robot (not shown) transfers wafer W, by elevating member 70 (a first upper position setting process). More particularly, lift shaft 45 is placed at the upper position by elevating member 70 and lift pin plate 40 fixedly connected to lift shaft 45 is placed at the upper position.

Next, wafer W is disposed on lift pin 41 of lift pin plate 40 by the wafer carrying robot (not shown) (a loading process) and the lower surface of wafer W is supported by lift pin 41 (a first support process).

Next, lift pin plate 40 is placed at the lower position, at which wafer W is processed with cleaning liquids C and R, by elevating member 70 (a lower position setting process). More particularly, lift shaft 45 is placed at the lower position by elevating member 70 and lift pin plate 40 fixedly connected to lift shaft 45 is placed at the lower position.

Lift pin plate 40 is placed at the lower position while wafer W is held by means of holding part 31 of holding plate 30 (a hold process) (see FIG. 1).

Next, rotating shaft 35 rotates by rotation driving part 60 and wafer W held by holding plate 30 rotates (a rotation process) (see FIG. 1). Further, the following processes are performed while wafer W held by holding plate 30 rotates.

First, chemical liquid C is supplied to the lower surface of wafer W (the surface of a holding part 31 side) by chemical-liquid supply part 16 (a chemical-liquid supply process) (see FIG. 2(a)). More particularly, in a state where chemical-liquid supply valve 11a of multi-valve 10 is opened and rinsing-liquid supply valve 12a, chemical-liquid discharge valve 11b, and rinsing-liquid discharge valve 12b are closed, chemical liquid C is supplied from chemical-liquid supply part 16. Therefore, chemical liquid C supplied from chemical-liquid supply part 16 passes through chemical-liquid supply pipe 1a, multi-valve 10, and cleaning-liquid supply pipe 5 in sequence and is supplied to the lower surface of wafer W.

Further, chemical liquid C supplied to the lower surface of wafer W flows from a center toward an outside of a circumferential periphery in the lower surface of wafer W by the centrifugal force applied to wafer W. Accordingly, the lower surface of wafer W is processed by chemical liquid C, but at this time, chemical liquid C scatters to be attached to lift pin plate 40 (including lift pin 41) and holding plate 30 below the lower surface of wafer W.

Next, chemical liquid C supplied in the chemical-liquid supply process is discharged (a chemical-liquid discharge process) (see FIG. 2(b)). More particularly, in a state where chemical-liquid discharge valve 11b of multi-valve 10 is opened and chemical-liquid supply valve 11a, rinsing-liquid supply valve 12a, and rinsing-liquid discharge valve 12b are closed, chemical liquid C within cleaning-liquid supply pipe 5 and multi-valve 10 is discharged to chemical-liquid discharge pipe 1b. Further, in the present embodiment, chemical liquid C discharged as above returns to chemical-liquid supply part 16 for reuse.

Next, rinsing liquid R is supplied to the lower surface of wafer W by rinsing-liquid supply part 17 (a preliminary rinsing-liquid supply process) (see FIG. 2 (c)). More particularly, in a state where rinsing-liquid supply valve 12a of multi-valve 10 is opened and chemical-liquid supply valve 11a, chemical-liquid discharge valve 11b, and rinsing-liquid discharge valve 12b are closed, rinsing liquid R is supplied from rinsing-liquid supply part 17. Therefore, rinsing liquid R supplied from rinsing-liquid supply part 17 passes through rinsing-liquid supply pipe 2a, multi-valve 10, and cleaning-liquid supply pipe 5 in sequence, and is supplied to the lower surface of wafer W.

Rinsing liquid R supplied to the lower surface of wafer W as described above also flows from the center toward the outside of the circumferential periphery in the lower surface of wafer W by the centrifugal force applied to wafer W. Therefore, the reaction by chemical liquid C on the lower surface of wafer W can be rapidly stopped. That is, in the present embodiment, the preliminary rinsing-liquid supply process of supplying a large amount of rinsing liquid R to the lower surface of wafer W at one stroke is performed prior to a valve rinsing process (described later) in which the amount of rinsing liquid R supplied to the lower surface of wafer W decreases, and thus it is possible to rapidly stop the reaction of the lower surface of wafer W with chemical liquid C.

Next, in a state where both rinsing-liquid supply valve 12a and rinsing-liquid discharge valve 12b of multi-valve 10 are opened and chemical-liquid supply valve 11a and chemical-liquid discharge valve 11b are closed, rinsing liquid R is supplied from rinsing-liquid supply part 17 (see FIG. 2(d)). A portion of rinsing liquid R supplied from rinsing-liquid supply part 17 is supplied to the lower surface of wafer W, and the residue of rinsing liquid R supplied from rinsing-liquid supply part 17 flows toward rinsing-liquid discharge pipe 2b within multi-valve 10 (the valve rinsing process).

As described above, according to the present embodiment, since rinsing liquid R supplied from rinsing-liquid supply part 17 flows toward rinsing-liquid discharge pipe 2b within multi-valve 10, it is possible to clean the inside of multi-valve 10 with rinsing liquid R. Therefore, it is possible to completely remove chemical liquid C attached to the inside of multi-valve 10 without increasing the time for supplying rinsing liquid R from rinsing-liquid supply part 17 and to process wafer W with the high throughput without over-etching.

That is, if not performing the valve rinsing process as in the prior art, it needs to increase the time (the time for the preliminary rinsing-liquid supply process and a additional rinsing-liquid supply process described later) for supplying rinsing liquid R from rinsing-liquid supply part 17 in order to remove chemical liquid C attached to the inside of multi-valve 10. Therefore, the throughput for processing wafer W deteriorates. Compared with this, according to the present embodiment, since rinsing liquid R supplied from rinsing-liquid supply part 17 can flow toward rinsing-liquid discharge pipe 2b within multi-valve 10, it is possible to completely clean the inside of multi-valve 10 with the rinsing liquid for a short time and to process wafer W with the high throughput without over-etching.

Further, opening rinsing-liquid supply valve 12a and continuously supplying rinsing liquid R to the lower surface of wafer W in the valve rinsing process prevents the lower surface of wafer W from being dried in a state where chemical liquid C has not completely removed from the lower surface of wafer W.

After the valve rinsing processing is finished as described above, the gas (for example, N₂) is supplied to the lower surface of wafer W by gas supply part 20 and rinsing liquid R is supplied to the lower surface of wafer W by rinsing-liquid supply part 17. More particularly, in a state where rinsing-liquid supply valve 12a of multi-valve 10 is opened and chemical-liquid supply valve 11a, chemical-liquid discharge valve 11b, and rinsing-liquid discharge valve 12b are closed, rinsing liquid R is supplied from rinsing-liquid supply part 17 and the gas is supplied by gas supply part 20. According to this, rinsing-liquid droplets are generated and these rinsing-liquid droplets are supplied to the lower surface of wafer W (a rinsing-liquid-droplet supply process) (see FIG. 2(e)).

Since rinsing liquid R and the gas are supplied at the same time to the surface of holding part 31 side of wafer W, a proceeding direction of rinsing liquid R supplied from the upper end of cleaning-liquid supply pipe 5 scatters by the force generated by the gas spreading from the upper end of gas supply pipe 25 to the outside of the circumferential periphery of wafer W and rinsing liquid R becomes droplets and spreads in every direction (see FIG. 1 and FIG. 2(e)).

Because of this, rinsing liquid R supplied from cleaning-liquid supply pipe 5 scatters on wafer W, lift pin plate 40, and holding plate 30 and conflicts with lift pin plate 40 (including lift pin 41) and holding plate 30. Further, rinsing liquid R attached to lift pin plate 40 flows toward holding plate 30 by the swirling flow generated by the rotation of holding plate 30 and wafer W, and rinsing liquid R on holding plate 30 flows toward the outside of the circumferential periphery of holding plate 30 by the centrifugal force applied to holding plate 30. Therefore, all the corners of lift pin plate 40 (including lift pin 41) and holding plate 30 are completely cleaned by rinsing liquid R.

As a result, when lift pin 41 is in contact with the lower surface of wafer W in a second support process described later, chemical liquid C attached to lift pin 41 is prevented from being attached to the lower surface of wafer W. Further, by the rotation of holding plate 30, it is also possible to prevent chemical liquid C attached to holding plate 30 from being attached to wafer W after a drying process (described later) or chemical liquid C attached to lift pin plate 40 or holding plate 30 from negatively affecting (contaminating) wafer W that is to be processed next time.

After the rinsing-liquid-droplet supply process is performed as described above, rinsing liquid R is supplied to the lower surface of wafer W by rinsing-liquid supply part 17 (a additional rinsing-liquid supply process) (see FIG. 2(f)). More particularly, in a state where rinsing-liquid supply valve 12a of multi-valve 10 is opened and chemical-liquid supply valve 11a, chemical-liquid discharge valve 11b, and rinsing-liquid discharge valve 12b are closed, rinsing liquid R is supplied from rinsing-liquid supply part 17. Therefore, rinsing liquid R supplied from rinsing-liquid supply part 17 passes through rinsing-liquid supply pipe 2a, multi-valve 10, and cleaning-liquid supply pipe 5 in sequence, and is supplied to the lower surface of wafer W.

Rinsing liquid R supplied to the lower surface of wafer W flows from the center toward the outside of the circumferential periphery in the lower surface of wafer W by the centrifugal force applied to wafer W. Since an amount of rinsing liquid R larger than the amount supplied to the lower surface of wafer W in the valve rinsing process and rinsing-liquid-droplet supply process is supplied to the lower surface of wafer W at one stroke in the additional rinsing-liquid supply process, it is possible to completely wash away chemical liquid C attached to the lower surface of wafer W.

In the present embodiment, since the rinsing-liquid-droplet supply process and additional rinsing-liquid supply process are performed after the valve rinsing process, it is possible to efficiently clean lift pin plate 40, holding plate 30, and the lower surface of wafer W with rinsing liquid R. That is, since lift pin plate 40 and holding plate 30 are cleaned with rinsing liquid R (the rinsing-liquid-droplet supply process) and the lower surface of wafer W is cleaned (the additional rinsing-liquid supply process) after completely washing away chemical liquid within multi-valve 10, it is possible to clean lift pin plate 40, holding plate 30, and the lower surface of wafer W with rinsing liquid R having a high purity. As a result, it is possible to efficiently clean lift pin plate 40, holding plate 30, and the lower surface of wafer W with rinsing liquid R.

After the additional rinsing-liquid supply process is performed as described above, rinsing liquid R supplied in the additional rinsing-liquid supply process is discharged (a rinsing-liquid discharge process) (see FIG. 2(g)). More particularly, in a state where rinsing-liquid discharge valve 12b of multi-valve 10 is opened and chemical-liquid supply valve 11a, rinsing-liquid supply valve 12a, and chemical-liquid discharge valve 11b are closed, rinsing liquid R within cleaning-liquid supply pipe 5 and multi-valve 10 is discharged through rinsing-liquid discharge pipe 2b. Further, in the present embodiment, rinsing liquid R discharged as above is processed as the draining liquid.

Next, the gas is supplied to the lower surface of wafer W by gas supply part 20 (the drying process) (see FIG. 2(h)). After the gas is supplied for an amount of time, the gas supply is stopped and the rotation of rotating shaft 35 by rotation driving part 60 is also stopped.

Next, lift pin plate 40 moves upwardly by elevating member 70 and wafer W is supported and lifted by lift pin 41 of lift pin plate 40 (a second support process). Thereafter, lift pin plate 40 is placed at the upper position, to which the wafer carrying robot (not shown) transfers wafer W (a second upper position setting process). Next, wafer W on lift pin 41 is unloaded by the wafer carrying robot (not shown) (an unload process).

In the present embodiment, a computer program to execute each process (from the first upper position setting process to the second upper position setting process) of the above-described liquid processing method is stored in a storage medium 52 (see FIG. 1). Further, the liquid processing apparatus includes a computer 55 to connect storage medium 52 and a control device 50 to receive a signal from computer 55. Control device 50 controls the liquid processing apparatus itself (at least rotation driving part 60, multi-valve 10, and gas supply part 20). Accordingly, by inserting storage medium 52 into (or attached to) computer 55, a series of the aforementioned liquid processing method can be executed on the liquid processing apparatus through control device 50. Storage medium 52 in the present disclosure includes CD, DVD, MD, a hard disk, and RAM.

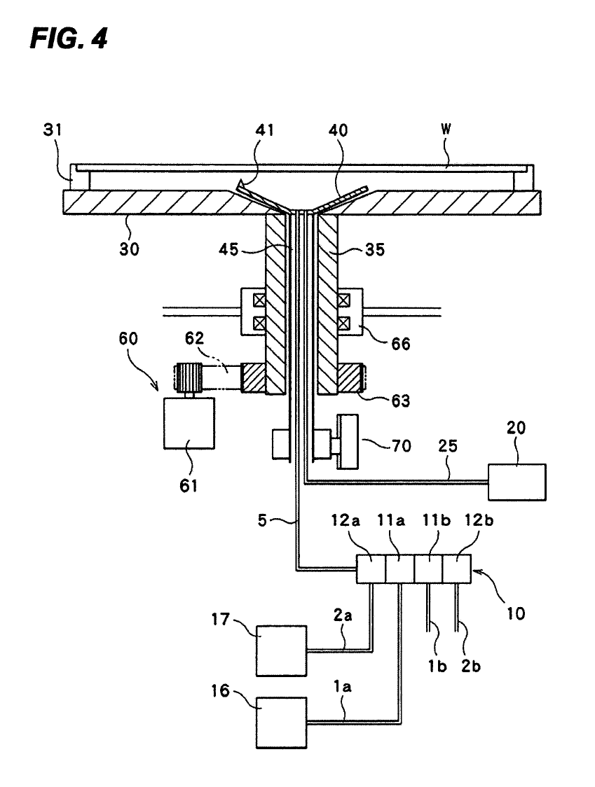

Further, in the above description, multi-valve 10 includes chemical-liquid supply valve 11a, rinsing-liquid supply valve 12a, chemical-liquid discharge valve 11b, and rinsing-liquid discharge valve 12b placed in sequence from one end (a left side of FIG. 1) toward the other end (a right side of FIG. 1), but is not limited thereto. For example, as shown in FIG. 4, multi-valve 10 may include rinsing-liquid supply valve 12a, chemical-liquid supply valve 11a, chemical-liquid discharge valve 11b, and rinsing-liquid discharge valve 12b placed in sequence from one end (a left side of FIG. 4) toward the other end (a right side of FIG. 4).

According to this aspect of multi-valve 10, in the valve rinsing process, rinsing liquid R introduced into multi-valve 10 from rinsing-liquid supply valve 12a placed at one end can be discharged in rinsing-liquid discharge valve 12b placed at the other end. Therefore, it is possible to more efficiently clean the inside of multi-valve 10 with rinsing liquid R and process wafer W with higher throughput.

Further, in the present embodiment, cleaning-liquid supply pipe 5 and gas supply pipe 25 are installed in parallel within lift shaft 45 and lift pin plate 40. A proceeding direction of rinsing liquid R supplied from the upper end of cleaning-liquid supply pipe 5 scatters by the force generated by the gas spreading from the upper end of gas supply pipe 25 to the outside of the circumferential periphery of wafer W. Therefore, rinsing liquid R becomes droplets and spreads in every direction.

However, the present disclosure is not limited thereto. For example, cleaning-liquid supply pipe 5 and gas supply pipe may be integrated within lift shaft 45 or within lift pin plate 40. In this case, the rinsing liquid and gas are mixed at a portion where cleaning-liquid supply pipe 5 and gas supply pipe are integrated. A proceeding direction of rinsing liquid R supplied from the upper end of cleaning-liquid supply pipe 5 (or gas supply pipe 25) scatters by the force generated by the gas spreading from the upper end of cleaning-liquid supply pipe 5 (or gas supply pipe 25) to the outside of the circumferential periphery of wafer W. Therefore, rinsing liquid R becomes droplets and spreads in every direction.

### Second Embodiment

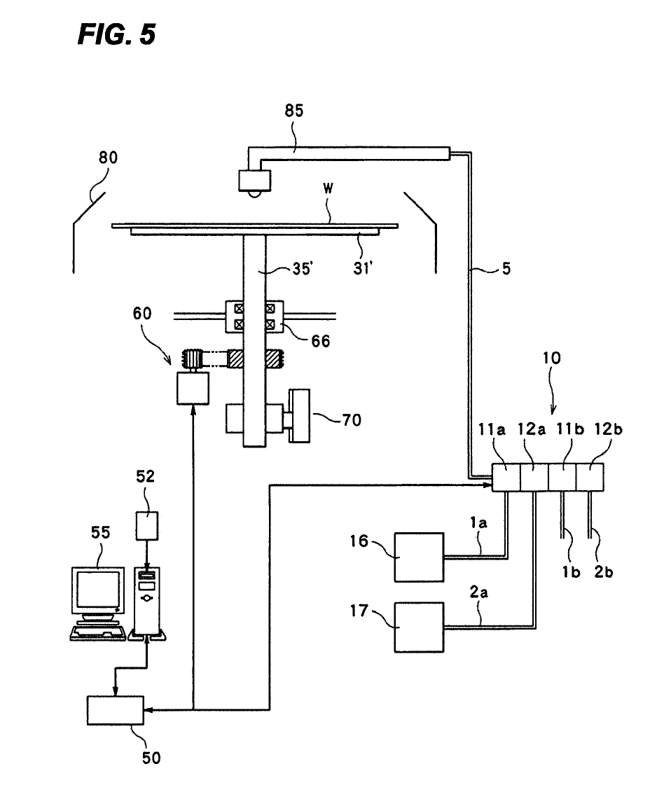

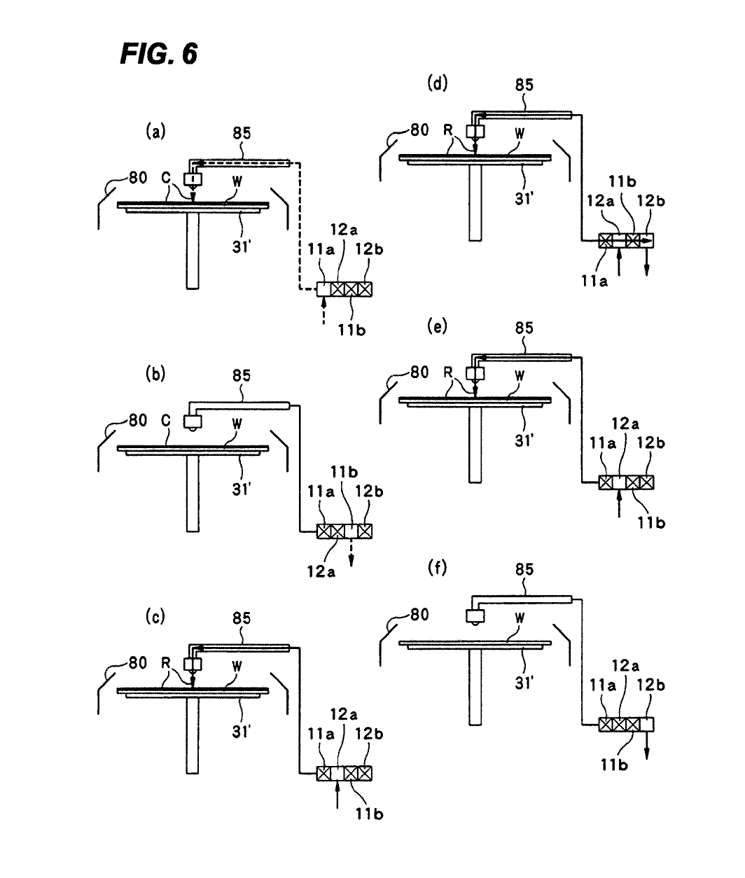

Next, a second embodiment of the present disclosure will be described with reference to FIGS. 5 and 6. In the second embodiment shown in FIGS. 5 and 6, the cleaning liquid is supplied to the upper surface of wafer W by a cleaning-liquid supply part 85, instead of supplying the cleaning liquid to the lower surface of wafer W, and other configurations are almost identical to those of the first embodiment shown in FIGS. 1 to 4. Further, in the second embodiment, a chamber 80 is installed in the liquid processing apparatus and the lower surface of to-be-processed wafer W is held by a holding part 31′ within chamber 80.

The portions of the second embodiment shown in FIGS. 5 and 6 substantially identical to those of the first embodiment shown in FIGS. 1 to 4 are denoted by the same reference number and their detailed description will be omitted.

Hereinafter, the operation and effect of the present embodiment will be described. Further, the operation and effect of the present embodiment is overlapped partly with those of the first embodiment in many aspects, so that it will be briefly described.

First, a rotating shaft 35′ moves upwardly by elevating member 70 and holding part 31′ is placed at the upper position (a first upper position setting process). Thereafter, wafer W is disposed on holding part 31′ within chamber 80 by the wafer carrying robot (not shown), and the lower surface of wafer W is held by holding part 31′ (a hold process) (see FIG. 5). Next, rotating shaft 35′ moves downwardly by elevating member 70 and holding part 31′ is placed at the lower position.

Next, rotating shaft 35′ rotates by rotation driving part 60 and wafer W held by holding part 31′ rotates (a rotation process) (see FIG. 5).

Next, chemical liquid C is supplied to the upper surface of wafer W (the surface opposite to holding part 31) by chemical-liquid supply part 16 (a chemical-liquid supply process) (see FIG. 6(a)). Further, chemical liquid C supplied to the upper surface of wafer W flows from the center toward the outside of the circumferential periphery on the upper surface of wafer W by the centrifugal force applied to wafer W. According to this, the upper surface of wafer W is processed with chemical liquid C.

Next, chemical liquid C supplied in the chemical-liquid supply process is discharged (a chemical-liquid discharge process) (see FIG. 6(b)).

Next, rinsing liquid R is supplied to the upper surface of wafer W by rinsing-liquid supply part 17 (a preliminary rinsing-liquid supply process) (see FIG. 6(c)). Rinsing liquid R supplied to the upper surface of wafer W as above also flows from the center toward the outside of the circumferential periphery on the upper surface of wafer W by the centrifugal force applied to wafer W. As a result, the reaction by chemical liquid C on the upper surface wafer W can be rapidly stopped.

Next, in a state where rinsing-liquid supply valve 12a and rinsing-liquid discharge valve 12b of multi-valve 10 are opened and chemical-liquid supply valve 11a and chemical-liquid discharge valve 11b are closed, rinsing liquid R is supplied from rinsing-liquid supply part 17. A portion of rinsing liquid R supplied from rinsing-liquid supply part 17 is supplied to the upper surface of wafer W and the residue of rinsing liquid R supplied from rinsing-liquid supply part 17 flows toward rinsing-liquid discharge pipe 2b within multi-valve 10 (a valve rinsing process) (see FIG. 6(d)).

Since rinsing liquid R supplied from rinsing-liquid supply part 17 flows toward rinsing-liquid discharge pipe 2b within multi-valve 10, it is possible to clean the inside of multi-valve 10 with rinsing liquid R. Therefore, chemical liquid C attached to the inside of multi-valve 10 can be completely removed without increasing the time for supplying rinsing liquid R from rinsing-liquid supply part 17 and wafer W can be processed with the high throughput.

After the valve rinsing process is finished as described above, rinsing liquid R is supplied to the upper surface of wafer W by rinsing-liquid supply part 17 (an additional rinsing-liquid supply process) (see FIG. 6(e)). Rinsing liquid R supplied to the upper surface of wafer W also flows from the center toward the outside of the circumferential periphery on the upper surface of wafer W by the centrifugal force applied to wafer W. Since an amount of rinsing liquid R larger than that supplied in the valve rinsing process is supplied to the upper surface of wafer W at one stroke in the additional rinsing-liquid supply process, it is possible to completely wash away chemical liquid C attached to the upper surface of wafer W.

After rinsing liquid R is supplied for an amount of time, the supply of rinsing liquid R is stopped, and then, rinsing liquid R supplied in the additional rinsing-liquid supply process is discharged (a rinsing-liquid discharge process) (see FIG. 6(f)). Thereafter, rotating shaft 35′ rotates by rotation driving part 60 only for an amount of time to dry wafer W, and then rotation of rotating shaft 35′ is stopped.

As such, when rotation of rotating shaft 35′ is stopped, rotating shaft 35′ moves upwardly by elevating member 70 and holding part 31′ is placed at the upper position (a second upper position setting process). Thereafter, wafer W on holding part 31′ is unloaded by the wafer carrying robot (not shown) (an unload process).

Even in the present embodiment, the computer program to execute each process (from the first upper position setting process to the second upper position setting process) of the above-described liquid processing method is stored in storage medium 52 (see FIG. 5). Further, the liquid processing apparatus includes computer 55 to connect storage medium 52 and control device 50 to receive a signal from computer 55. Control device 50 controls the liquid processing apparatus itself (at least rotation driving part 60 and multi-valve 10). Storage medium 52 is inserted into (or attached to) computer 55 and a series of the aforementioned liquid processing method can be executed on the liquid processing apparatus by control device 50.

Further, even in the present embodiment, multi-valve 10 may include rinsing-liquid supply valve 12a, chemical-liquid supply valve 11a, chemical-liquid discharge valve 11b, and rinsing-liquid discharge valve 12b placed in order from one end toward the other end (see FIG. 4).

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A liquid processing method to process a substrate with a chemical liquid and a rinsing liquid supplied through a multi-valve and a cleaning-liquid supply pipe connected to the multi-valve, the multi-valve comprising a chemical-liquid supply valve installed at a chemical-liquid supply pipe, a rinsing-liquid supply valve installed at a rinsing-liquid supply pipe, and a discharge valve installed at a discharge path, and the cleaning-liquid supply pipe guiding the chemical liquid and the rinsing liquid from the multi-valve toward the substrate, the method comprising:
supplying the chemical liquid supplied from a chemical-liquid supply part to the substrate through the cleaning-liquid supply pipe by opening the chemical-liquid supply valve; and
supplying a portion of the rinsing liquid supplied from a rinsing-liquid supply part to the substrate through the cleaning-liquid supply pipe and flowing the residue of the rinsing liquid toward the discharge path within the multi-valve by opening both the rinsing-liquid supply valve and the discharge valve after supplying the chemical liquid.

2. The liquid processing method of claim 1, further comprising additionally supplying to the substrate the rinsing liquid supplied from the rinsing-liquid supply part by opening the rinsing-liquid supply valve and closing the discharge valve after supplying the portion of the rinsing liquid to the substrate and flowing the residue of the rinsing liquid toward the discharge path within the multi-valve.

3. The liquid processing method of claim 1, further comprising discharging the chemical liquid within the cleaning-liquid supply pipe by opening the discharge valve after supplying the chemical liquid.

4. The liquid processing method of claim 1, further comprising preliminarily supplying the rinsing liquid supplied from the rinsing-liquid supply part to the substrate by opening the rinsing-liquid supply valve prior to supplying the portion of the rinsing liquid to the substrate and flowing the residue of the rinsing liquid toward the discharge path within the multi-valve.

5. The liquid processing method of claim 2, further comprising discharging the rinsing liquid within the cleaning-liquid supply pipe by opening the discharge valve after additionally supplying the rinsing liquid.

6. A liquid processing apparatus, comprising:
a multi-valve comprising a chemical-liquid supply valve installed at a chemical-liquid supply pipe, a rinsing-liquid supply valve installed at a rinsing-liquid supply pipe, and a discharge valve installed at a discharge path;
a chemical-liquid supply part to supply a chemical liquid for processing a substrate;
a rinsing-liquid supply part to supply a rinsing liquid for processing the substrate;
a cleaning-liquid supply pipe connected to the multi-valve so as to guide the chemical liquid and the rinsing liquid from the multi-valve toward the substrate; and
a control device to control the multi-valve,
wherein the control device allows the chemical liquid to be supplied from the chemical-liquid supply part to the substrate by opening the chemical-liquid supply valve, and then the control device allows the rinsing liquid to be supplied from the rinsing-liquid supply part to the substrate and flow toward the discharge path within the multi-valve by opening both the rinsing-liquid supply valve and the discharge valve.

7. The liquid processing apparatus of claim 6, wherein the control device allows the rinsing liquid to be supplied from the rinsing-liquid supply part to the substrate by opening the rinsing-liquid supply valve and closing the discharge valve after opening both the rinsing-liquid supply valve and the discharge valve.

8. The liquid processing apparatus of claim 6, wherein the control device allows the rinsing liquid to be supplied from the rinsing-liquid supply part to the substrate by opening only the rinsing-liquid supply valve prior to opening both the rinsing-liquid supply valve and the discharge valve.

9. A storage medium storing a computer program to execute a liquid processing method in a liquid processing apparatus, the liquid processing apparatus comprising a multi-valve and a cleaning-liquid supply pipe connected to the multi-valve, the multi-valve comprising a chemical-liquid supply valve installed at a chemical-liquid supply pipe, a rinsing-liquid supply valve installed at a rinsing-liquid supply pipe, and a discharge valve installed at a discharge path, and the cleaning-liquid supply pipe guiding the chemical liquid and the rinsing liquid from the multi-valve toward a substrate, the liquid processing method comprising:
supplying the chemical liquid supplied from a chemical-liquid supply part to the substrate through the cleaning-liquid supply pipe by opening the chemical-liquid supply valve; and
supplying a portion of the rinsing liquid supplied from a rinsing-liquid supply part to the substrate through the cleaning-liquid supply pipe and flowing the residue of the rinsing liquid toward the discharge path within the multi-valve by opening both the rinsing-liquid supply valve and the discharge valve after supplying the chemical liquid.
